(19) United States
(12) Patent Application Publication
(10) Pub. No.: US 2024/0035385 A1
(43) Pub. Date: Feb. 1, 2024

(54) TURBOMACHINE ROTOR HAVING IMPROVED VIBRATORY BEHAVIOUR

(71) Applicant: SAFRAN AIRCRAFT ENGINES, Paris (FR)

(72) Inventors: Sylvain PHOURATSAMAY, Moissy-Cramayel (FR); Sylvain Frédéric AVAKIAN, Moissy-Cramayel (FR); Mickael CAVAREC, Moissy-Cramayel (FR)

(73) Assignee: SAFRAN AIRCRAFT ENGINES, Paris (FR)

(21) Appl. No.: 18/264,343

(22) PCT Filed: Feb. 1, 2022
(86) PCT No.: PCT/FR2022/050188

§ 371 Date: Aug. 4, 2023

(30) Foreign Application Priority Data
Feb. 10, 2021 (FR) FR2101263

(51) Int. Cl. F01D 5/16

(52) U.S. Cl. CPC F01D 5/16; F05D 2260/96

(57) ABSTRACT

Assembly comprising a body extending around a central axis, the body having an outer surface from which a plurality of blades extend, each of said blades having a blade root and a blade tip, defining an inner radial end and an outer radial end of the blade relative to the central axis, said blades having the same blade height measured radially relative to the central axis, characterized in that each of the blades is connected to the body by its blade root via a connection having a nonzero connection height, so that for the plurality of said blades, the connection height of two successive blades is different.

### TECHNICAL FIELD

The present disclosure relates to the field of bladed elements, and in particular finds a particular application for impellers, particularly in the context of a turbomachine rotor.

### PRIOR ART

The present disclosure relates in particular to impellers or bladed disks, employed in particular in turbomachines, for example turbojets. The impellers are in fact elements subjected to vibratory phenomena which can have a significant impact on the operation of a system. Two types of phenomena are distinguished: synchronous phenomena and asynchronous phenomena.

Synchronous phenomena result from an interaction between the rotor and the stator of a system. The geometry of the elements of the stator creates an exciting wake on the parts in rotation. The frequency of vibration is then an integral multiple of the speed of rotation.

Asynchronous phenomena correspond to purely aerodynamic excitation: the frequency is independent of the speed of rotation. The latter can be particularly destructive for blading if it is self-induced, for example in the case of flutter.

In order to limit asynchronous phenomena, it is known to use deliberate detuning, which consists of forming groups of blades having different vibratory properties, for example different stiffnesses and masses, which limits the transmission of energy between the different blades and thus limits the risk of self-induced flutter.

However, the usual deliberate detuning solutions have an impact which can be strongly negative on aerodynamic performance, which is not satisfactory. Moreover, in certain cases an increase in synchronous phenomena can be observed, which naturally is therefore unsatisfactory.

The present disclosure thus seeks to respond at least partially to these problems.

### DISCLOSURE OF THE INVENTION

To this end, the present disclosure relates to a turbomachine rotor comprising a body extending around a central axis, the body having an outer surface from which a plurality of blades extends, each of said blades having a blade root and a blade tip, defining an inner radial end and an outer radial end of the blade relative to the central axis, said blades having the same blade height measured radially relative to the central axis, characterized in that each of the blades is connected to the body by its blade root via a connection having a nonzero connection height, so that for the plurality of said blades, the connection height of two successive blades is different.

According to one example, for each blade, the connection has a connection height comprised between 2% and 13% of the blade height.

According to one example, the difference between the connection heights of the connections of two successive blades is comprised between 1% and 5% of the blade height.

According to one example, the difference between the connection heights of the connections of two successive blades is comprised between 2% and 3% of the blade height.

According to one example, the connection height of the blades to the body varies according to a sinusoidal profile.

According to one example, the connection height of the blades to the body varies according to a triangular profile.

According to one example, the body is an annular body having a central recess.

According to one example, for each blade, the connection between the body and the blade root is accomplished with a fillet having a circular portion cross-section.

According to one example, for each blade, the connection between the body and the blade root is accomplished so as to have a variable radius of curvature.

According to one example, the body and the blades form a single-piece bladed disk.

The present disclosure also relates to a turbomachine comprising a turbomachine rotor as previously defined.

### BRIEF DESCRIPTION OF THE DRAWINGS

The invention and its advantages will be better understood upon reading the detailed description given hereafter of different embodiments of the invention, given by way of non-limiting examples.

FIG. 1 is a view of a single-piece bladed disk according to one example of application of the invention.

FIG. 2 is another view of a single-piece bladed disk according to one example of application of the invention.

FIG. 3 is a graph showing an example of evolution of the minimum radius of curvature of an assembly according to one aspect of the invention.

FIG. 4 is a graph showing another example of evolution of the minimum radius of curvature of an assembly according to one aspect of the invention.

FIG. 5 shows schematically the definition of the connection height.

In the plurality of the figures, common elements are labeled by identical numerical references.

### DESCRIPTION OF THE EMBODIMENTS

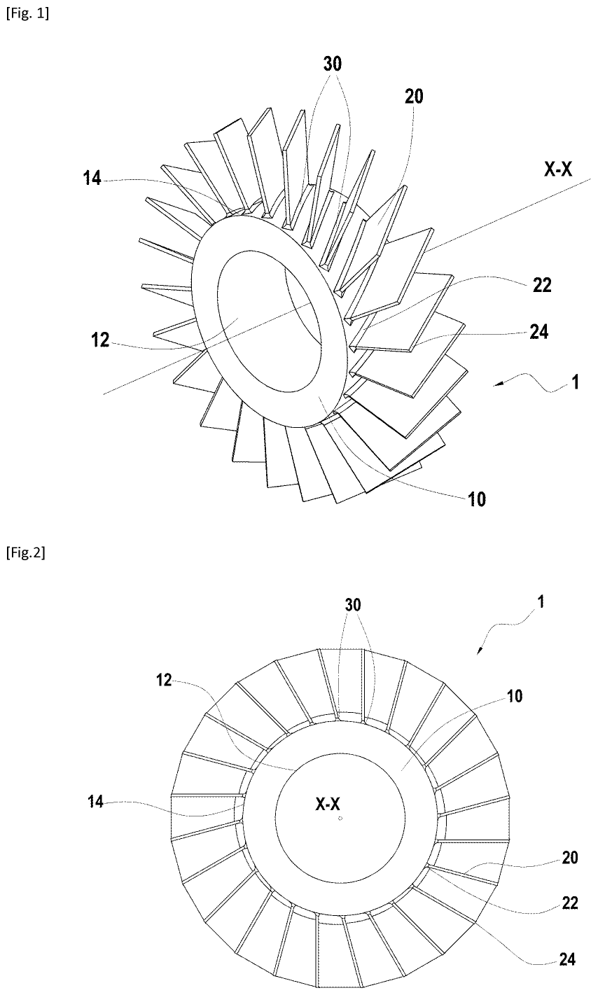

FIGS. 1 and 2 are two views of an assembly 1 according to one aspect of the invention, which is shown here in the form of a single-piece bladed disk 1. The single-piece bladed disk 1 as shown is an example of application of the invention, particularly in the context of a turbomachine rotor. As will be understood upon reading the description, the invention can be applied more generally to a component comprising a body having a plurality of blades, and being subjected to vibratory phenomena. The single-piece bladed disk 1 comprises [a body] 10 and a plurality of blades 20.

The body 10 as shown is an annular body extending around a central axis X-X defining a longitudinal direction. The body 10 as shown comprises an inner face 12 extending to an inner diameter relative to the longitudinal axis, and an outer face 14 extending to an outer diameter relative to the central axis X-X.

The blades 20 extend radially relative to the central axis X-X, from the outer face 14 of the body 10.

A blade root 22 and a blade tip 24, which respectively define the inner radial end and the outer radial end of the blade 20 relative to the central axis X-X, are defined for each blade 20. The blades 20 typically show the same outer radius relative to the central axis X-X, in particular in the case of an application for a rotating element, the outer radius being the distance between the central axis X-X and the blade tip 24.

The link between the blades 20 and the body 10 has a connection 30, so as to avoid sharp angles which generate stress concentrations.

Conventionally, the blades 20 and the connections 30 are identical over the entire outer periphery of the body 10.

The present disclosure proposes, however, a different approach, and proposes to vary the geometry of the connection 30 linking the blades 20 to the body 10.

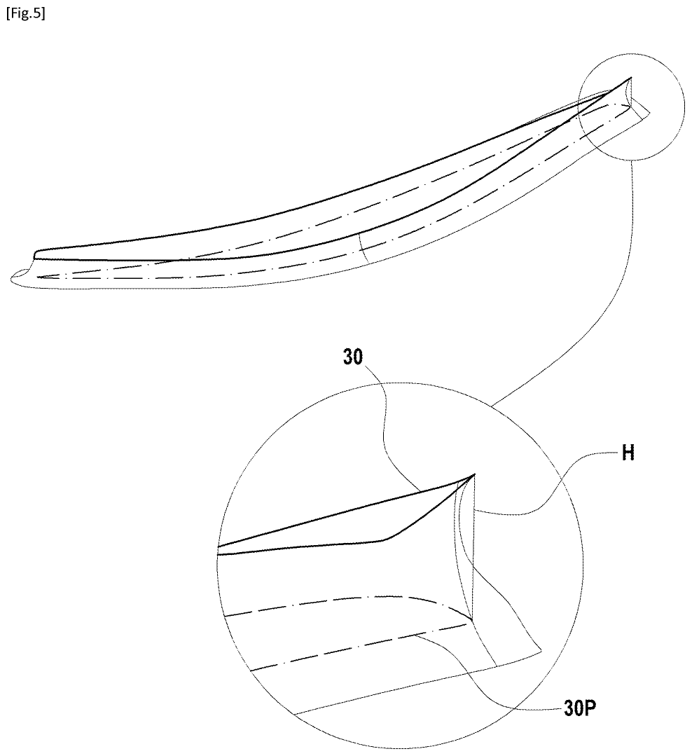

A connection height is defined for each connection 30. The connection height corresponds to the distance, measured in the radial direction, between the outer radial end of the connection and its projection in the radial direction onto the inner stream. FIG. 5 shows schematically an example of the definition of the connection height H relative to a connection 30 and its projection 30P.

Seen in particular in FIG. 2 is that, for each blade 20, the connection height corresponding to the connection 30 considered evolves according to the angular position of the associated blade 20 relative to the central axis X-X. The connection height corresponds to the height of the connection 30 considered to be measured in the radial direction relative to the axis X-X. More precisely, the connection height of the connections 30 linking the roots of the blades 20 is not constant over the entire periphery of the body 10.

According to one example, this variation of the connection height is accomplished by varying the minimum radius of curvature of the connections 30 linking the roots of the blades 20.

In order to vary the connection height, the connections 30 can have different shapes. They typically have a variable or constant connection height, or possibly a variable or constant radius of curvature, or can for example have one or more portions with a variable connection height, or possibly a variable radius of curvature, and one or more portions with variable or constant connection height, or possibly a constant radius of curvature.

According to one example, the connections 30 form fillets having a circular portion cross section, the minimum radius of curvature is then equal to the radius of the fillet, and the connection height is then typically equal to the radius of the fillet.

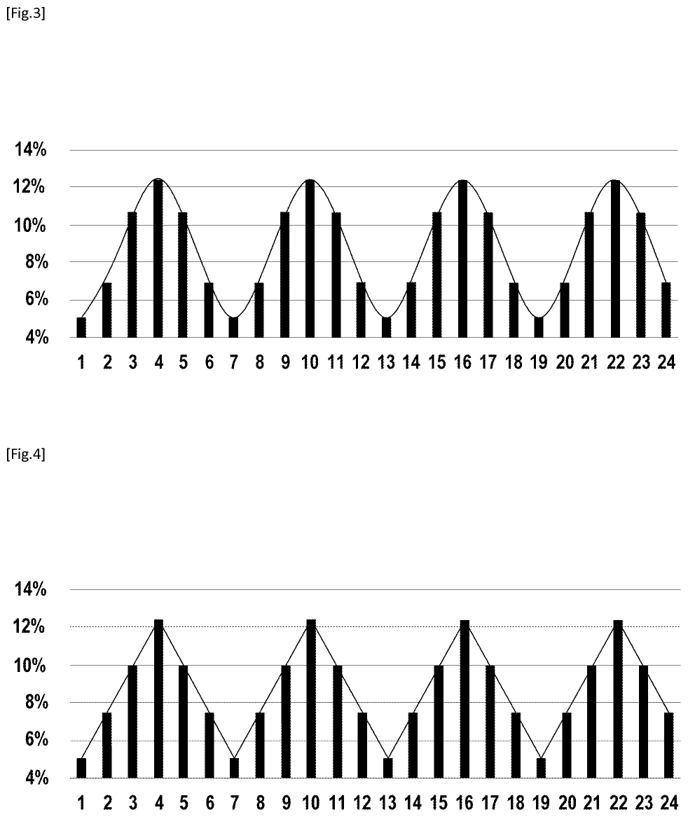

FIGS. 3 and 4 illustrate two examples of evolution of the connection height via the evolution of the minimum radius of curvature for the different blades 20, the value of the minimum radius of curvature being measured here relative to the height H of the blades 20, i.e. the maximum distance between the blade root 22 and the blade tip 24 for the blade 20 considered, the blades 20 typically having an identical height.

The variations of the evolution of the connection height for the different blades 20 form patterns, indicated in FIGS. 3 and 4, that are characterized as detuning patterns.

Different detuning patterns can be defined here.

In the example illustrated in FIG. 3, the connections 30 form a sinusoidal pattern. In the example illustrated in FIG. 4, the connections 30 form a triangular pattern. It is understood that the patterns are designed particularly depending on the number of blades 20 and on the number of distinct values which are adopted for the detuning pattern considered. It is also understood that these examples of patterns are not limiting.

As can be seen in these figures, the connection heights, or typically the minimum radii of curvature for the different connections 30, typically have a value comprised between 2% and 13% of the height H, or even between 5% and 13% of the height H.

The connection heights, or possibly the minimum radii of curvature of the different connections 30, are typically accomplished so that for two successive blades 20, the difference between the connection heights, or possibly the minimum radii of curvature of their respective connections 30, are comprised between 1% and 5% of H, or for example between 2% and 3% of H. The connections 30 of two successive blades 20 are thus never equal.

As can be seen in the figures, for each tuning pattern several values of minimum connection height, or possibly of minimum radius of curvature are defined. In the examples shown, 4 values of minimum connection height are distinguished, or more precisely of minimum radius of curvature. It is understood that the number of values can vary, and is typically greater than 2.

It has been observed that a variation of minimum connection heights of this type, or possibly of minimum radii of curvature of the different connections 30, allows reducing the level of synchronous responses on the order of 10% to 30%. The impact in terms of flow rate and of efficiency for the assembly is moreover minimal, even negligible, and the implementation of such detuning patterns therefore does not impact the operability of the assembly.

The present disclosure thus allows accomplishing detuning by modifying the geometry of the connections 30 between the blades 20 and the body 10. The variation of the connection heights or possibly of the minimum radii of curvature of the different connections 30 as proposed allows having a frequency gap between adjacent blades that is sufficiently constant to ensure asynchronous vibratory stability while improving robustness for synchronous responses.

The invention as proposed can for example apply to a turbomachine component such as a single-piece bladed disk, or more generally to any component comprising a body having a plurality of blades and being subjected to vibratory phenomena.

The invention can in particular apply to a turbomachine component forming a turbomachine rotor, movable in rotation along the central axis X-X relative to a stator of the turbomachine.

Although the present invention has been described by referring to specific exemplary embodiments, it is obvious that modifications and changes can be carried out on these examples without departing from the general scope of the invention as defined by the claims. In particular, individual features of the different embodiments illustrated/mentioned can be combined into additional embodiments. Consequently, the description and the drawings should be considered in an illustrative, rather than a restrictive sense.

It is also obvious that all the features described with reference to a method are transposable, alone or in combination, to a device, and conversely all the features described with reference to a device are transposable, alone or in combination, to a method.

1. A turbomachine rotor comprising a body extending around a central axis, the body having an outer surface from which a plurality of blades extends,
each of said blades having a blade root and a blade tip, defining an inner radial end and an outer radial end of the blade relative to the central axis, said blades having the same blade height measured radially relative to the central axis,
characterized in that
each of the blades is connected to the body by its blade root via a connection having a nonzero connection height, so that for the plurality of said blades, the connection height of two successive blades is different.

2. The turbomachine rotor according to claim 1, wherein, for each blade, the connection has a connection height comprised between 2% and 13% of the blade height.

3. The turbomachine rotor according to claim 1, wherein the difference between the connection heights of two successive blades is comprised between 1% and 5% of the blade height.

4. The turbomachine rotor according to claim 3, wherein the difference between the connection heights of two successive blades is comprised between 2% and 3% of the blade height.

5. The turbomachine rotor according to claim 1, wherein the evolution of the connection height of the blades to the body varies according to a sinusoidal profile.

6. The turbomachine rotor according to claim 1, wherein the evolution of the connection height of the blades to the body varies according to a triangular profile.

7. The turbomachine rotor according to claim 1, wherein the body is an annular body having a central recess.

8. The turbomachine rotor according to claim 1, wherein, for each blade, the connection between the body and the blade root is accomplished with a fillet having a circular portion cross-section.

9. The turbomachine rotor according to claim 1, wherein, for each blade, the connection between the body and the blade root is accomplished so as to have a variable radius of curvature.

10. The turbomachine rotor according to claim 1, wherein the body and the blades form a single-piece bladed disk.

11. A turbomachine comprising a turbomachine rotor according to claim 1.
